(19) United States
(12) Patent Application Publication
(10) Pub. No.: US 2025/0217621 A1
(43) Pub. Date: Jul. 3, 2025

(54) DETERMINING SIMULATION FIDELITY USING NEURAL NETWORK EMBEDDINGS

(71) Applicant: GM Cruise Holdings LLC, San Francisco, CA (US)

(72) Inventor: James Hryniw, San Francisco, CA (US)

(21) Appl. No.: 18/402,405

(22) Filed: Jan. 2, 2024

(51) Int. Cl. G06N 3/044; B60W 60/00; G06N 3/084

(52) U.S. Cl. CPC G06N 3/044; G06N 3/084; B60W 60/001

(57) ABSTRACT

Systems and techniques are provided for determining simulation fidelity. An example method includes receiving, by a machine learning model, a plurality of input datasets that are generated as part of a simulated scene within a simulation environment; generating, by the machine learning model, a plurality of outputs that are based on the plurality of input datasets; and determining, by a discriminator head of the machine learning model, a plurality of input classifiers for each of the plurality of outputs, wherein each input classifier from the plurality of input classifiers indicates whether input data corresponding to a respective output from the plurality of outputs is associated with simulated input data or real-world input data.

### BACKGROUND

### 1. Technical Field

The present disclosure generally relates to autonomous vehicles and, more specifically, to determining simulation fidelity using neural network embeddings.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. In some cases, the autonomous vehicle may process sensor data using software algorithms that include artificial intelligence and/or machine learning models.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a diagram illustrating an example system environment that can be used to facilitate autonomous vehicle (AV) navigation and routing operations, according to some examples of the present disclosure;

FIG. 2 is a diagram illustrating an example simulation framework, according to some examples of the present disclosure;

FIG. 3 is a diagram illustrating an example system that can be used to train a machine learning model to generate an input classifier for determining simulation fidelity, according to some examples of the present disclosure;

FIG. 4 is a diagram illustrating an example system that includes a machine learning model configured to generate an input classifier for determining simulation fidelity, according to some examples of the present disclosure;

FIG. 5 is a flowchart illustrating an example process for determining simulation fidelity, according to some examples of the present disclosure;

FIG. 6 illustrates an example of a deep learning neural network that can be used to determine simulation fidelity, according to some aspects of the present disclosure;

FIG. 7 is a flowchart illustrating an example process for training a machine learning model to determine simulation fidelity, according to some examples of the present disclosure, according to some examples of the present disclosure;

FIG. 8 is a flowchart illustrating an example process for determining simulation fidelity, according to some examples of the present disclosure; and

FIG. 9 is a diagram illustrating an example system architecture for implementing certain aspects described herein, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Autonomous vehicles (AVs), also known as self-driving cars, driverless vehicles, and robotic vehicles, are vehicles that use sensors to sense the environment and move without human input. For example, AVs can include sensors such as a camera sensor, a LIDAR sensor, and/or a RADAR sensor, amongst others, which the AVs can use to collect data and measurements that are used for various AV operations. The sensors can provide the data and measurements to an internal computing system of the autonomous vehicle, which can use the data and measurements to control mechanical systems of the autonomous vehicle, such as a vehicle propulsion system, a braking system, and/or a steering system, etc.

In some cases, AV software can be tested using different simulation frameworks. For example, a replay simulation framework can be used to create simulations that use real-world AV data. In some aspects, a replay simulation framework can provide accurate simulation results because the behavior of the simulated AV can be compared to the real-world behavior of the AV. In addition, a replay simulation framework may provide accurate simulation results because the AV software that is being tested (e.g., perception stack, planning stack, controls stack, etc.) receives and processes data corresponding to real-world sensor measurements (e.g., LiDAR sensor data, RADAR sensor data, camera sensor data, etc.).

In some aspects, AV software can also be tested using a synthetic simulation framework that is used to create simulations based on synthetic data (e.g., simulated sensor data provided as input to AV software). In some cases, a synthetic simulation framework may be required to test AV software that cannot be tested using a replay simulation framework. For example, AV software associated with next-generation AVs that are fully autonomous and, in some cases, do not have a steering wheel, may be tested using a synthetic simulation framework prior to being deployed to an AV in a real-world environment.

However, in some cases, such simulation frameworks may be unreliable (e.g., have a relatively low fidelity). That is, distributional differences may be observed between synthetic simulations and real-world scenarios. In some cases, it may be difficult to determine or quantify the severity of these distributional differences and/or understand how severely these differences impact the machine learning models that are being tested using the simulation framework.

Systems, apparatuses, processes (also referred to as methods), and computer-readable media (collectively referred to as “systems and techniques”) are described herein for determining (e.g., quantifying) simulation fidelity using neural network embeddings. In some aspects, a machine learning model can be configured to have a discriminator head that is coupled to one or more intermediate layers. In some cases, the discriminator head can be trained to classify a scene (e.g., input data) as being sourced from real-world data or from simulation data. That is, the discriminator head can be trained (e.g., using a real-world dataset and a synthetic dataset) to discern distributional differences between real-world data and simulation data.

In some aspects, the trained machine learning model that includes the discriminator head can be used in a simulation framework to determine the simulation fidelity. For example, an input classifier as determined by the discriminator head can be used to determine a fidelity score. In some cases, the fidelity score can be a classification-threshold invariant measure of accuracy. That is, the fidelity score can be a measure of fidelity for simulation. In some aspects, the higher the accuracy of the discriminator head (e.g., the better the model learns distributional differences and is able to distinguish between synthetic data and real-world data), the lower the fidelity score. Conversely, in some examples, a higher fidelity score can be achieved when the discriminator head is confused and unable to identify differences between synthetic data and real-world data (e.g., simulation data is not distinguishable from real-world data).

In some examples, use of a discriminator head that determines (e.g., quantifies) the fidelity of a simulation framework can improve the reliability of a simulation framework. That is, in some cases, the fidelity score can be used to identify simulation frameworks that do not accurately represent real-world environments and/or to identify aspects of a simulation framework that does not accurately represent real-world environments. Simulation frameworks may then be modified or refined in order to better mimic real-world environments (e.g., improve fidelity) and therefore, improve the development and testing of software by using a controlled environment. Improvement to simulation frameworks may also reduce the amount of testing required in the field (e.g., using an actual AV) and/or may reduce the risk associated with deploying and testing new software in the field.

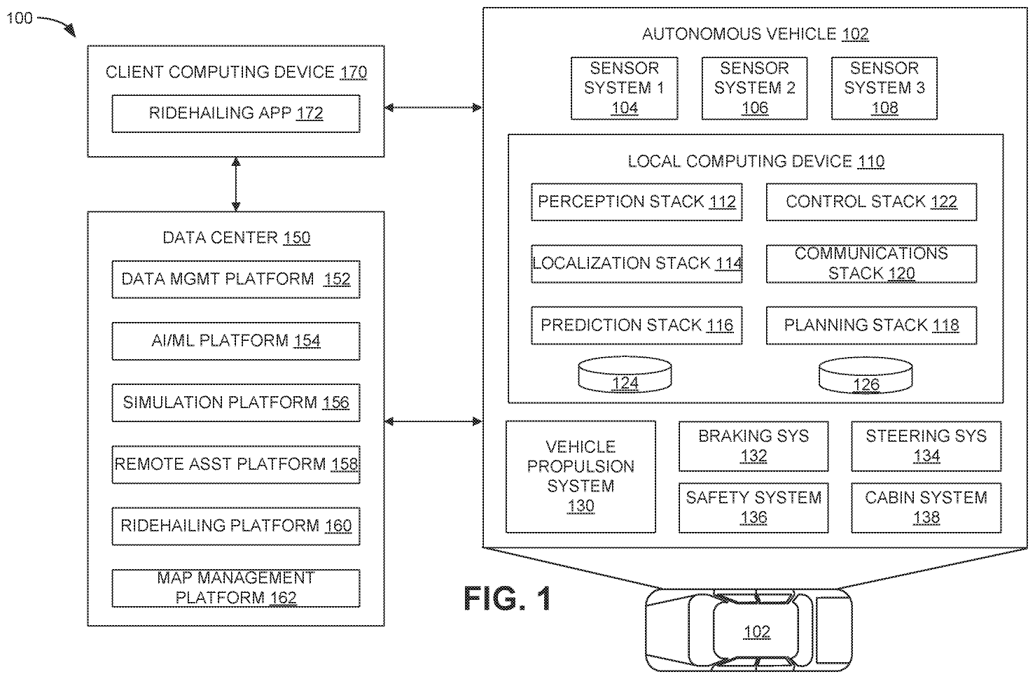

FIG. 1 is a diagram illustrating an example autonomous vehicle (AV) environment 100, according to some examples of the present disclosure. One of ordinary skill in the art will understand that, for AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

Perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the perception stack 112 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

Prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

Planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

Control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

Communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls layer can include geospatial information of traffic signal lights, traffic signs, and other road objects and related attributes.

AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

Data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ride-hailing service (e.g., a ridesharing service), a delivery service, a remote/roadside assistance service, street services (e.g., street mapping, street patrol, street cleaning, street metering, parking reservation, etc.), and the like.

Data center 150 can send and receive various signals to and from the AV 102 and the client computing device 170. These signals can include sensor data captured by the sensor systems 104-108, roadside assistance requests, software updates, ride-hailing/ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ride-hailing platform 160, and a map management platform 162, among other systems.

Data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ride-hailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

Simulation platform 156 can enable testing and validation of the algorithms, machine learning models, neural networks, and other development efforts for the AV 102, the remote assistance platform 158, the ride-hailing platform 160, the map management platform 162, and other platforms and systems. Simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

Remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

Ride-hailing platform 160 can interact with a customer of a ride-hailing service via a ride-hailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 172. The client computing device 170 can be a customer's mobile computing device or a computing device integrated with the AV 102 (e.g., the local computing device 110). The ride-hailing platform 160 can receive requests to pick up or drop off from the ride-hailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ride-hailing platform 160 may incorporate the map viewing services into the ride-hailing application 172 to enable passengers to view the AV 102 in transit en route to a pick-up or drop-off location, and so on.

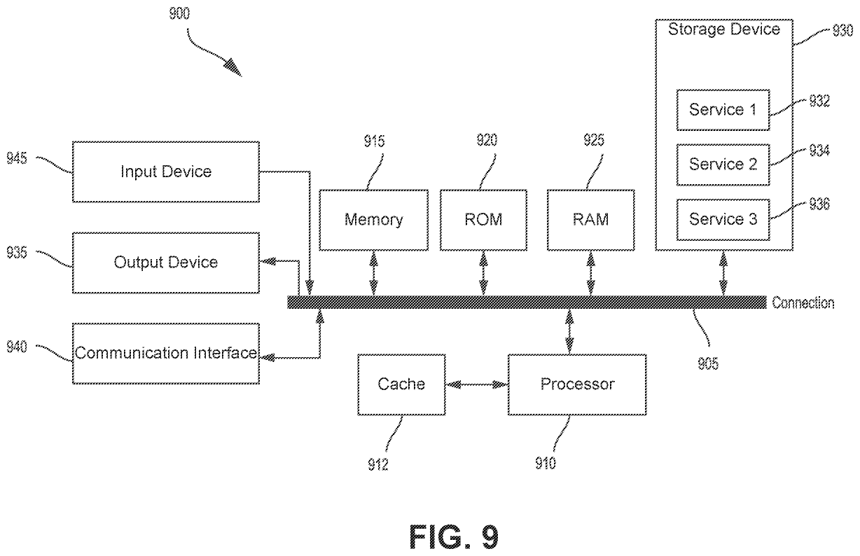

While the autonomous vehicle 102, the local computing device 110, and the autonomous vehicle environment 100 are shown to include certain systems and components, one of ordinary skill will appreciate that the autonomous vehicle 102, the local computing device 110, and/or the autonomous vehicle environment 100 can include more or fewer systems and/or components than those shown in FIG. 1. For example, the autonomous vehicle 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 9.

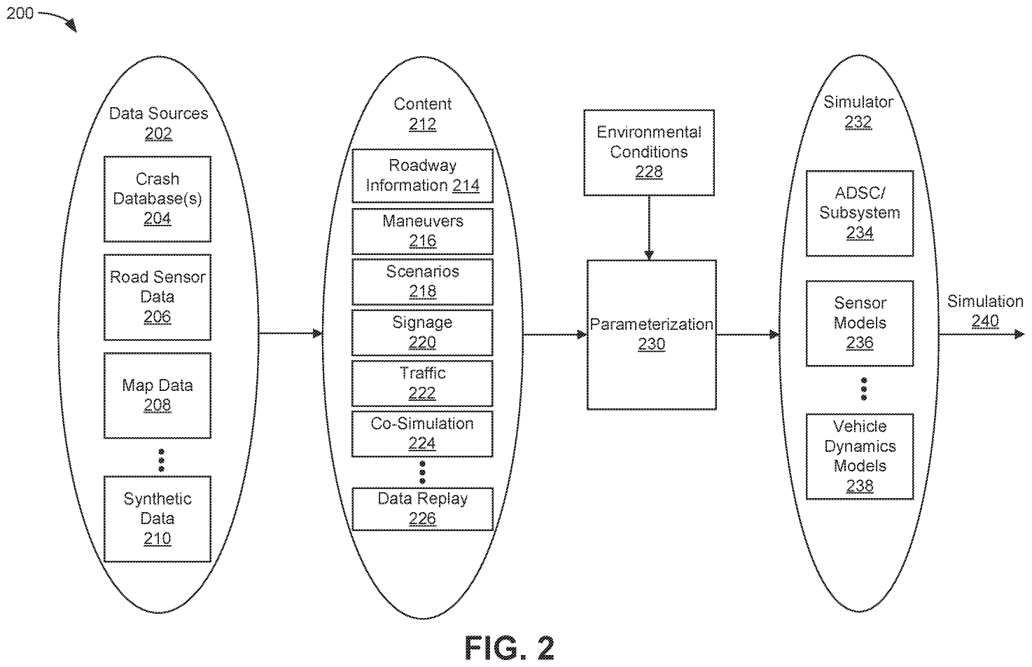

FIG. 2 is a diagram illustrating an example simulation framework 200, according to some examples of the present disclosure. The example simulation framework 200 can include data sources 202, content 212, environmental conditions 228, parameterization 230, and simulator 232. The components in the example simulation framework 200 are merely illustrative examples provided for explanation purposes. In other examples, the simulation framework 200 can include other components that are not shown in FIG. 2 and/or more or less components than shown in FIG. 2.

The data sources 202 can be used to create a simulation. The data sources 202 can include, for example and without limitation, one or more crash databases 204, road sensor data 206, map data 208, and/or synthetic data 210. In other examples, the data sources 202 can include more or less sources than shown in FIG. 2 and/or one or more data sources that are not shown in FIG. 2.

The crash databases 204 can include crash data (e.g., data describing crashes and/or associated details) generated by vehicles involved in crashes. The road sensor data 206 can include data collected by one or more sensors (e.g., one or more camera sensors, LiDAR sensors, RADAR sensors, SONAR sensors, IMU sensors, GPS/GNSS receivers, and/or any other sensors) of one or more vehicles while the one or more vehicles drive/navigate one or more real-world environments. The map data 208 can include one or more maps (and, in some cases, associated data) such as, for example and without limitation, one or more high-definition (HD) maps, sensor maps, scene maps, and/or any other maps. In some examples, the one or more HD maps can include roadway information such as, for example, lane widths, location of road signs and traffic lights, directions of travel for each lane, road junction information, speed limit information, etc.

The synthetic data 210 can include virtual assets, objects, and/or elements created for a simulated scene, a virtual scene and/or virtual scene elements, and/or any other synthetic data elements. For example, in some cases, the synthetic data 210 can include one or more virtual vehicles, virtual pedestrians, virtual roads, virtual objects, virtual environments/scenes, virtual signs, virtual backgrounds, virtual buildings, virtual trees, virtual motorcycles/bicycles, virtual obstacles, virtual environmental elements (e.g., weather, lightening, shadows, etc.), virtual surfaces, etc. In some aspects, the synthetic data 210 can include synthetic sensor data such as synthetic camera data, synthetic LiDAR data, synthetic RADAR data, synthetic IMU data, and/or any other type of synthetic sensor data. In some cases, the synthetic data 210 can be generated using real-world data from any of the other data sources 202 (e.g., synthetic data 210 can be based on data from crash database 204, road sensor data 206, map data 208, etc.).

In some examples, data from some or all of the data sources 202 can be used to create the content 212. The content 212 can include static content and/or dynamic content. For example, the content 212 can include roadway information 214, maneuvers 216, scenarios 218, signage 220, traffic 222, co-simulation 224, and/or data replay 226. The roadway information 214 can include, for example, lane information (e.g., number of lanes, lane widths, directions of travel for each lane, etc.), the location and information of road signs and/or traffic lights, road junction information, speed limit information, road attributes (e.g., surfaces, angles of inclination, curvatures, obstacles, etc.), road topologies, and/or other roadway information. The maneuvers 216 can include any AV maneuvers, and the scenarios 218 can include specific AV behaviors in certain AV scenes/environments. The signage 220 can include signs such as, for example, traffic lights, road signs, billboards, displayed messages on the road, etc. The traffic 222 can include any traffic information such as, for example, traffic density, traffic fluctuations, traffic patterns, traffic activity, delays, positions of traffic, velocities, volumes of vehicles in traffic, geometries or footprints of vehicles, pedestrians, spaces (occupied and/or unoccupied), etc.

The co-simulation 224 can include a distributed modeling and simulation of different AV subsystems that form the larger AV system. In some cases, the co-simulation 224 can include information for connecting separate simulations together with interactive communications. In some cases, the co-simulation 224 can allow for modeling to be done at a subsystem level while providing interfaces to connect the subsystems to the rest of the system (e.g., the autonomous driving system computer). Moreover, the data replay 226 can include replay content produced from real-world sensor data (e.g., road sensor data 206).

The environmental conditions 228 can include any information about environmental conditions 228. For example, the environmental conditions 228 can include atmospheric conditions, road/terrain conditions (e.g., surface slope or gradient, surface geometry, surface coefficient of friction, road obstacles, etc.), illumination, weather, road and/or scene conditions resulting from one or more environmental conditions, etc.

The content 212 and the environmental conditions 228 can be used to create the parameterization 230. The parameterization 230 can include parameter ranges, parameterized scenarios, probability density functions of one or more parameters, sampled parameter values, parameter spaces to be tested, evaluation windows for evaluating a behavior of an AV in a simulation, scene parameters, content parameters, environmental parameters, etc. The parameterization 230 can be used by a simulator 232 to generate a simulation 240.

The simulator 232 can include a software engine(s), algorithm(s), neural network model(s), and/or software component(s) used to generate simulations, such as simulation 240. In some examples, the simulator 232 can include autonomous driving system computer (ADSC)/subsystem models 234, sensor models 236, and a vehicle dynamics model 238. The ADSC/subsystem models 234 can include models, descriptors, and/or interfaces for the ADSC and/or ADSC subsystems such as, for example, a perception stack (e.g., perception stack 112), a localization stack (e.g., localization stack 114), a prediction stack (e.g., prediction stack 116), a planning stack (e.g., planning stack 118), a communications stack (e.g., communications stack 120), a control stack (e.g., control stack 122), a sensor system(s), and/or any other subsystems.

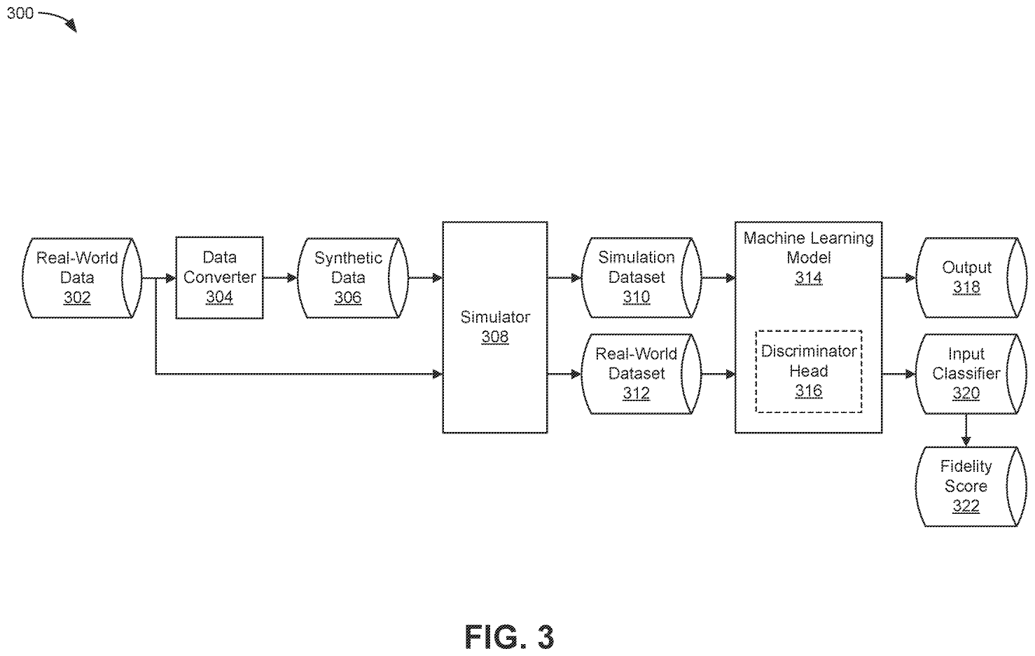

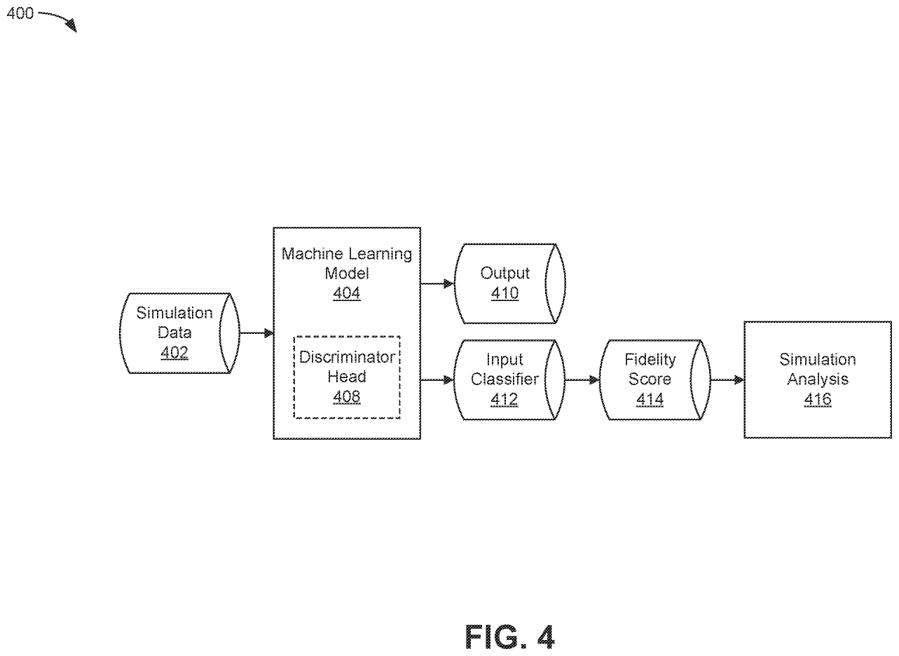

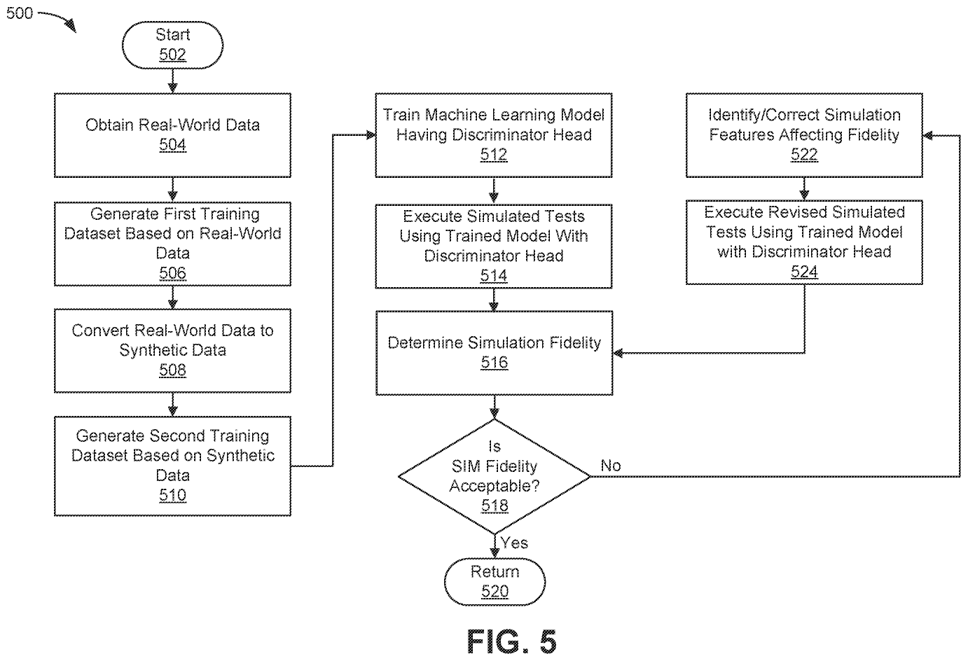

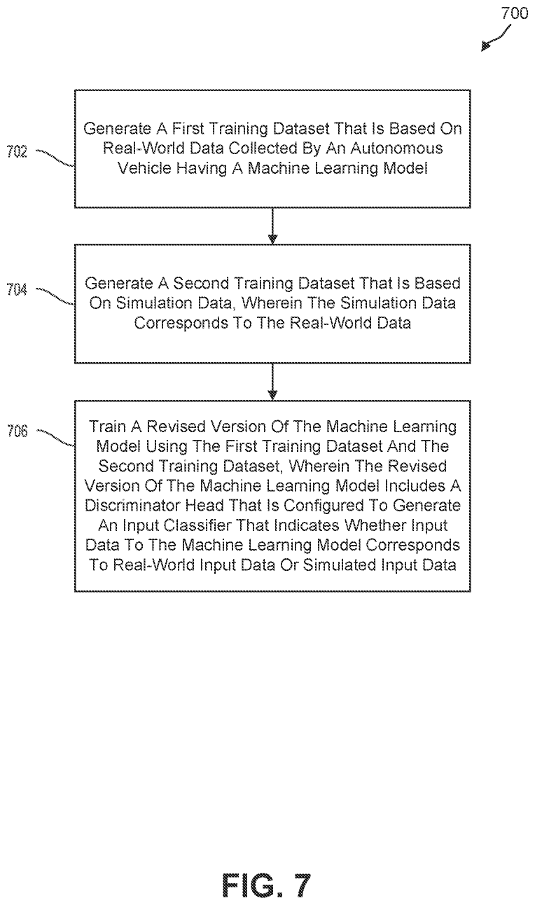

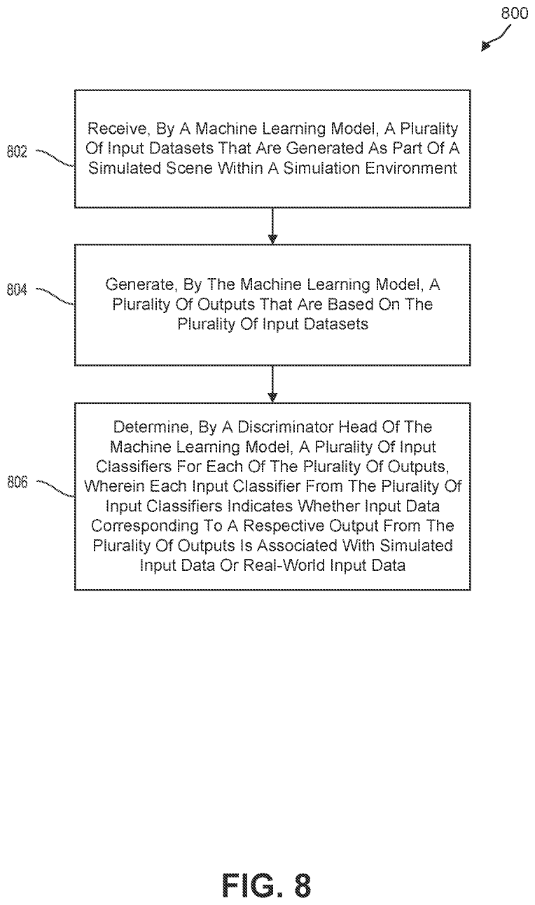

In some examples, the ADSC/subsystem models 234 can include a discriminator head that is configured (e.g., trained) to generate an input classifier that classifies the input data to the model as synthetic (e.g., simulated) data or real-world data. In some cases, the input classifier can be used to determine a fidelity score for the simulation 240. In one illustrative example, the fidelity score for the simulation 240 may be relatively low when the discriminator head is able to determine that the input corresponds to synthetic data greater than a threshold percentage of time (e.g., greater than 50% of the time). Additional details regarding determination of simulation fidelity are discussed below with respect to FIG. 3, FIG. 4, FIG. 5, FIG. 7, and FIG. 8.

The sensor models 236 can include mathematical representations of hardware sensors and an operation (e.g., sensor data processing) of one or more sensors (e.g., a LiDAR, a RADAR, a SONAR, a camera sensor, an IMU, and/or any other sensor). For example, sensor models 236 can include a LiDAR sensor model that simulates operation of a LiDAR sensor. That is, a LiDAR sensor model can be used to simulate transmission of LiDAR beams in the simulation 240 and can simulate LiDAR measurements such as range, intensity, etc. corresponding to one or more objects in the simulation 240. The vehicle dynamics model 238 can model vehicle behaviors/operations, vehicle attributes, vehicle trajectories, vehicle positions, etc.

FIG. 3 is a diagram illustrating an example system 300 that can be used to train a machine learning model 314 to generate an input classifier for determining (e.g., quantifying, measuring, calculating, etc.) simulation fidelity. In some aspects, system 300 may include real-world data 302. In some examples, real-world data 302 can include any type of data collected by an electronic device or an autonomous system such as autonomous vehicle 102, an unmanned aerial vehicle or drone, an autonomous robot, etc. For instance, real-world data 302 may include sensor data (e.g., camera sensor data, LiDAR sensor data, radar sensor data, etc.) corresponding to a scene or environment in which an autonomous system operates. In some configurations, real-world data 302 may include crash databases 204, road sensor data 206, and/or map data 208.

In some aspects, real-world data 302 can include the output of a querying or filtering operation. That is, real-world data 302 may correspond to a subset of a larger set of real-world data that has been identified or selected based on one or more characteristics. For example, real-world data 302 may include a set of events, scenes, scenarios, etc. that are distributionally representative of an activity. In one illustrative example corresponding to an autonomous vehicle, real-world data 302 may include data that is distributionally representative of road driving.

In some examples, system 300 can include a data converter 304 that can be configured to convert real-world data 302 into synthetic data 306. For example, data converter 304 can process real-world data 302 to identify elements in a real-world scene such as pedestrians, vehicles, buildings, traffic lights, signs, etc. These scene elements can be extracted into synthetic data 306 in order to run simulations (e.g., using simulator 308) that are based on the real-world data 302.

In some configurations, system 300 can include simulator 308. In some cases, simulator 308 may be configured to replay or repeat a scenario or situation that is based on real-world data 302. For example, real-world data 302 corresponding to an autonomous vehicle making an unprotected left turn at a specific intersection can be replayed using simulator 308 such that the autonomous vehicle in the simulated environment interacts with the same objects (e.g., oncoming vehicles, pedestrians, traffic light, etc.) and operates in the same or similar manner as the real-world autonomous vehicle.

In some aspects, simulator 308 can replay one or more test scenarios using real-world data 302 in order to generate real-world dataset 312. In some cases, real-world dataset 312 can include data that is provided as input to a machine learning model (e.g., machine learning model 314). For example, real-world dataset 312 can include data that may be provided as input to perception stack 112, localization stack 114, prediction stack 116, planning stack 118, communications stack 120, control stack 122, and/or any other machine learning model.

In some aspects, simulator 308 can be configured to execute simulated tests using synthetic data 306 (e.g., based on real-world data 302). For example, scene elements such as vehicles, pedestrians, signage, etc. in synthetic data 306 can be used to create a simulation environment that can be used to run one or more tests. In some cases, synthetic data 306 may also include synthetic sensor data. For instance, synthetic data 306 may include synthetic LIDAR data corresponding to an object in the scene and the synthetic LIDAR data can be provided to a machine learning model configured to perform object detection based on the synthetic LIDAR data. In some examples, synthetic data 306 may include synthetic tracking data for objects in the scene. In one illustrative example, synthetic tracking data may be generated by processing (e.g., smoothing) tracking data for an object from real-world data 302.

In some aspects, simulator 308 can run one or more test simulations using synthetic data 306 in order to generate simulation dataset 310. In some cases, simulation dataset 310 can include data that is provided as input to a machine learning model (e.g., machine learning model 314). Simulation dataset 310 can differ from real-world dataset 312 in that simulation dataset 310 is based on simulation testing that utilizes synthetic data 306 while real-world dataset 312 is based on replay simulation testing that utilizes real-world data 302. In some cases, simulation dataset 310 can be generated using simulator 308 by configuring the position of the simulated entity (e.g., the autonomous vehicle) for every tick of the simulation. That is, the position (e.g., for each tick) of the simulated entity can be adjusted according to real-world data 302 so that simulation dataset 310 can be aligned with real-world dataset 312. In some aspects, such a configuration may be used to ensure that a test scenario that is based on real-world dataset 316 has a corresponding (e.g., equivalent) test scenario that is based on simulation dataset 310 (e.g., or vice-versa).

In some examples, simulation dataset 310 and real-world dataset 312 can be used to train machine learning (ML) model 314. The output 318 of ML model 314 can include an object detection, an object classification, a bounding box, a predicted path, a predicted position, a confidence value, any other type of classification/prediction, and/or any combination thereof. In some cases, ML model 314 may correspond to a machine learning model used by an autonomous vehicle such as AV 102. For instance, ML model 314 may correspond to perception stack 112, localization stack 114, prediction stack 116, planning stack 118, communications stack 120, control stack 122, and/or any other machine learning model.

In some aspects, ML model 314 may include a discriminator head 316 that is configured (e.g., trained) to determine an input classifier 320 that classifies a scene as being sourced from real-world data 302 or synthetic data 306. That is, discriminator head 316 can be trained using simulation dataset 310 and real-world dataset 312 to learn distributional differences between real-world data and simulation (e.g., synthetic) data.

In some configurations, the discriminator head 316 may correspond to a single hidden layer neural network that is on top of a feature vector of the ML model 314. In some examples, discriminator head 316 can determine input classifier 320 based on an embedding (e.g., feature vector) of ML model 314. In one illustrative example, discriminator head 316 may be coupled to an embedding layer of ML model 314 that generates a feature vector that stitches together data from multiple compression layers. For instance, the embedding layer that is coupled to discriminator head 316 may combine embeddings from a layer that compress features associated with a non-player character (NPC), which can include all other actors in a scene (e.g., vehicles, pedestrians, animals, etc.); a layer that compresses scene features; and/or a layer that compresses costs (e.g., safety costs, comfort costs, collision costs, etc.). In some cases, discriminator head 316 may be coupled to an earlier compression layer. That is, discriminator head 316 can determine input classifier 320 based on an intermediate embedding or an intermediate feature vector.

In some cases, ML model 314 may have been trained previously (e.g., using a different dataset). For example, ML model 314 may correspond to a machine learning model that is configured to operate on AV 102 and has been trained to perform one or more functions. In some aspects, ML model 314 may correspond to a modified version of a previously trained model. That is, an existing ML model can be modified to include discriminator head 316. In some cases, simulation dataset 310 and real-world dataset 312 can be used to provide additional training to the ML model 314 that can also be used to train the discriminator head 316 to generate input classifier 320.

In some examples, the input classifier 320 can be used to determine a fidelity score 322. In some cases, fidelity score 322 can be a classification-threshold invariant measure of accuracy. That is, fidelity score 322 can be a measure of fidelity for simulation. In some aspects, the higher the accuracy of ML model 314 at predicting input classifier 320 (e.g., the better the model learns distributional differences and is able to distinguish between synthetic data and real-world data), the lower the fidelity score 322. Conversely, in some configurations, a high value for fidelity score 322 can be achieved when ML model 314 is confused and unable to identify differences between synthetic data and real-world data (e.g., simulation data is not distinguishable from real-world data). That is, a desirable simulation fidelity can be achieved when the discriminator head 316 has approximately a 50% accuracy rate, which means the simulation environment is not distinguishable from a real-world environment.

In some cases, fidelity score 322 can be based on an area under the receiver operating characteristic (ROC) curve (AUC). In one illustrative example, a simulation fidelity index (SFI) can be determined using fidelity score 322, according to Equation (1) below, in which f1 corresponds to the fidelity score 322 for a particular simulation framework experiment.

$$SFI = 1 - ( 2 * abs ( 0.5 - f 1 ) ) \qquad ( 1 )$$

It is noted that Equation (1) provides a transformation that maps fidelity score 322 into [0,1] range, in which a value of ‘0’ corresponds to the worst fidelity score 322 and a value of ‘1’ corresponds to the best fidelity score.

FIG. 4 is a diagram illustrating an example system 400 that includes a machine learning (ML) model 404 configured to generate an input classifier 412 for determining simulation fidelity. In some cases, ML model 404 can correspond to ML model 314, as described in connection with FIG. 3. For example, ML model 404 can include a discriminator head 408 that is trained to identify differences between real-world data and simulation data (e.g., synthetic data) based on an embedding (e.g., feature vector) of ML model 404. As noted above, ML model 404 can include any type of model (e.g., models associated with AV 102) that is trained to generate an output 410 that can include object detections, object classifications, bounding boxes, confidence scores, etc.

In some aspects, ML model 404 can be used in a simulation framework (e.g., simulator 232) to determine simulation fidelity. That is, ML model 404 can be used to determine to what degree a simulation framework accurately represents a real-world environment based on the ability of discriminator head 408 to distinguish between simulation data and real-world data.

In some cases, ML model 404 can receive simulation data 402. Simulation data 402 can include any type of data that can be used to generate a scene for testing operation of ML model 404. For instance, simulation data 402 may include data for creating a simulated scene that includes a double-parked vehicle that is blocking a traffic lane navigated by an autonomous vehicle. Simulation data 402 may include additional data for other elements within the scene such as pedestrians, road paint, weather conditions, etc. Simulation data 402 may also include synthetic sensor data that mimics sensor data that may be collected by various sensors on an autonomous vehicle (e.g., sensor systems 104-108). Simulation data 402 may also include synthetic tracking data that defines the position and/or path of one or more actors within a simulated scene.

In some aspects, ML model 404 can make one or more predictions or decisions (e.g., output 410) based on simulation data 402. For instance, ML model 404 may direct the path of an autonomous vehicle around the double-parked vehicle in the simulated environment. In some examples, discriminator head 408 can process (e.g., evaluate) embeddings or feature vectors within ML model 404 that correspond to output 410 and generate an input classifier 412. The input classifier 412 can identify simulation data 402 as being synthetic data (e.g., discriminator head 408 can identify simulation data 402) or the input classifier 412 can identify simulation data 402 as being real-world data (e.g., discriminator head 408 can be confused by simulation data 402 and classify it as real-world data).

In some configurations, the input classifier 412 can be used to determine a fidelity score 414 that can be used to quantify the simulation fidelity. As noted above with respect to fidelity score 322 in FIG. 3, the fidelity score 414 can improve (e.g., enhance fidelity) when discriminator head 408 is unable to accurately determine whether simulation data 402 corresponds to synthetic data or real-world data.

In some aspects, the fidelity score 414 can be tracked throughout a simulation (e.g., on a per-tick basis). For instance, the fidelity score 414 may indicate a relatively high fidelity as the autonomous vehicle in the example noted above approaches the double-parked vehicle and the fidelity score 414 may indicate a decrease in fidelity as the autonomous vehicle encroaches into an adjacent traffic lane to circumvent the double-parked vehicle.

In some cases, simulation analysis 416 can include one or more algorithms that can process the input classifier 412 and/or the fidelity score 414 to improve the fidelity of a simulation framework. For example, simulation analysis 416 can include a gradient analysis that can be used to determine the relative feature importance to discriminator head 408. In furtherance of the example above, simulation analysis 416 may be used to determine that a modification to the track footprint or the track kinematics as the autonomous vehicle passes the double-parked vehicle caused the fidelity to decrease. That is, the track kinematics can be identified as a feature that facilitated classification of simulation data 402 as synthetic data by discriminator head 408.

In some aspects, the identified feature can be modified, and the simulation can be re-run to ascertain changes (e.g., improvement) in simulation fidelity (e.g., based on fidelity score 414). For example, a developer can make spoofing improvements and/or modifications to simulation data 402 that can improve simulation fidelity. In some cases, simulation analysis 416 can evaluate a confidence level that corresponds to each input classifier 412 prediction. For example, an input classifier 412 that identifies simulation data 402 as being synthetic data with a relatively high confidence level (e.g., greater than 60% confidence) may be indicative of a feature vector that includes a distributional difference that improves the accuracy of discriminator head 408 and therefore reduces fidelity of the simulation framework.

FIG. 5 illustrates a flowchart of an example process 500 for determining simulation fidelity. The process 500 may begin at step 502, which may include initializing of hardware or software systems associated with one or more simulation frameworks (e.g., an autonomous vehicle (AV) replay simulation environment, an AV synthetic simulation environment, etc.) and/or with any other computing device that may be configured to execute one or more steps in process 500.

In some examples, process 500 may include step 504 in which real-world data can be obtained. In some aspects, real-world data can include any type of data collected and/or generated by an entity configured to operate using one or more machine learning models. For instance, the real-world data may correspond to data collected by AV 102. In some examples, the real-world data may correspond to real-world data 302, which may be representative of a scenario or condition that is to be tested by a simulation framework (e.g., the real-world data can be distributionally representative of road driving by an autonomous vehicle).

At step 506, the process 500 can include generating a first training dataset based on the real-world data. In some examples, the first training dataset can be generated by using a replay simulator to execute one or more test scenarios using the real-world data. For instance, simulator 308 can be used to generate real-world dataset 312 based on real-world data 302.

At step 508, the process 500 can include converting the real-world data to synthetic data. For instance, a converter such as data converter 304 can process the real-world data to generate synthetic data 306. The conversion process may include identifying and extracting one or more scene elements from the real-world data such as objects, weather, signs, vehicles, etc.

At step 510, the process 500 can include generating a second training dataset that is based on the synthetic data. In some aspects, the second training dataset can be generated by using a synthetic simulation environment that executes test scenarios that are substantially the same as the tests performed using the replay simulator. For instance, simulator 308 can be used to generate simulation dataset 310 based on synthetic data 306.

At step 512, the process 500 can include training a machine learning model having a discriminator head that is configured to classify a scene as being sourced from real-world data or from synthetic data. For example, simulation dataset 310 and real-world dataset 312 can be used to train ML model 314 having discriminator head 316 that is configured to classify a scene (e.g., input classifier 320) based on one or more feature vectors or embeddings of ML model 314.

At step 514, the process 500 can include executing simulated tests using the trained ML model with a discriminator head. For example, ML model 404 can include discriminator head 408 that is trained to generate input classifier 412. Simulated tests can be executed using simulation data 402 and discriminator head 408 can classify the input data (e.g., simulation data 402) associated with each output 410 (e.g., and/or for every simulation tick) as being based on real-world data or synthetic data.

At step 516, the process 500 can include determining simulation fidelity. For example, the simulation fidelity (e.g., fidelity score 414) can be determined using the input classifier 412. In some aspects, the simulation fidelity can be based on the ROC area under curve score (e.g., a classification-threshold invariant measure of accuracy).

At step 518, the process 500 can include determining whether the simulation fidelity is acceptable. For example, the simulation fidelity may be acceptable when fidelity score 414 is greater than or equal to a minimum threshold. In some cases, an ideal fidelity score can correspond to an AUC value of 0.5. In some configurations, an acceptable simulation fidelity may correspond to a fidelity score 414 that has an AUC value between 0.4 and 0.6.

In some aspects, if the simulation fidelity is acceptable, the process may proceed to step 520 and return to prior processing, which may include repeating one or more steps from process 500. Alternatively, if the simulation fidelity is below a minimum threshold, the process 500 may proceed to step 522, which can include identifying and/or correcting simulation features that are affecting the simulation fidelity. For instance, simulation analysis 416 can be performed to identify elements or features of simulation data 402 that are adversely affecting the simulation fidelity (e.g., features that are increasing the accuracy of discriminator head 408).

At step 524, the process 500 can include executing revised simulation tests using the trained model with the discriminator head. For example, one or more aspects of simulation data 402 may be modified to help improve the simulation fidelity and the revised simulation can be executed using ML model 404 that includes discriminator head 408. Simulation fidelity for the revised simulated test can be determined at step 516 and the simulation fidelity can be evaluated, as described with respect to step 518.

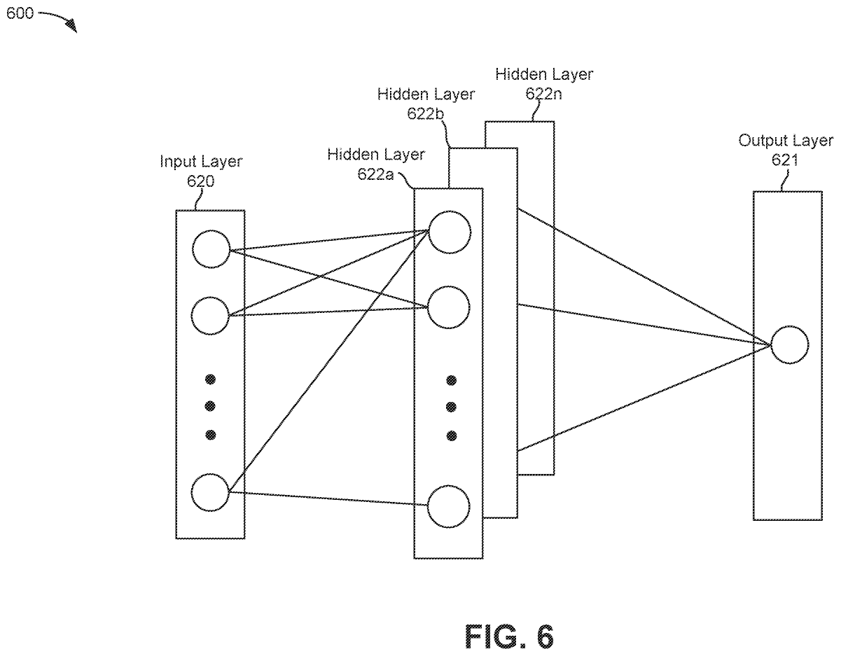

FIG. 6 is a diagram illustrating an example of a neural network architecture 600 that can be used to implement some or all of the neural networks described herein. The neural network architecture 600 can include an input layer 620 can be configured to receive and process data to generate one or more outputs. The neural network architecture 600 also includes hidden layers 622a, 622b, through 622n. The hidden layers 622a, 622b, through 622n include “n” number of hidden layers, where “n” is an integer greater than or equal to one. The number of hidden layers can be made to include as many layers as needed for the given application. The neural network architecture 600 further includes an output layer 621 that provides an output resulting from the processing performed by the hidden layers 622a, 622b, through 622n.

The neural network architecture 600 is a multi-layer neural network of interconnected nodes. Each node can represent a piece of information. Information associated with the nodes is shared among the different layers and each layer retains information as information is processed. In some cases, the neural network architecture 600 can include a feed-forward network, in which case there are no feedback connections where outputs of the network are fed back into itself. In some cases, the neural network architecture 600 can include a recurrent neural network, which can have loops that allow information to be carried across nodes while reading in input.

Information can be exchanged between nodes through node-to-node interconnections between the various layers. Nodes of the input layer 620 can activate a set of nodes in the first hidden layer 622a. For example, as shown, each of the input nodes of the input layer 620 is connected to each of the nodes of the first hidden layer 622a. The nodes of the first hidden layer 622a can transform the information of each input node by applying activation functions to the input node information. The information derived from the transformation can then be passed to and can activate the nodes of the next hidden layer 622b, which can perform their own designated functions. Example functions include convolutional, up-sampling, data transformation, and/or any other suitable functions. The output of the hidden layer 622b can then activate nodes of the next hidden layer, and so on. The output of the last hidden layer 622n can activate one or more nodes of the output layer 621, at which an output is provided. In some cases, while nodes in the neural network architecture 600 are shown as having multiple output lines, a node can have a single output and all lines shown as being output from a node represent the same output value.

In some cases, each node or interconnection between nodes can have a weight that is a set of parameters derived from the training of the neural network architecture 600. Once the neural network architecture 600 is trained, it can be referred to as a trained neural network, which can be used to generate one or more outputs. For example, an interconnection between nodes can represent a piece of information learned about the interconnected nodes. The interconnection can have a tunable numeric weight that can be tuned (e.g., based on a training dataset), allowing the neural network architecture 600 to be adaptive to inputs and able to learn as more and more data is processed.

The neural network architecture 600 is pre-trained to process the features from the data in the input layer 620 using the different hidden layers 622a, 622b, through 622n in order to provide the output through the output layer 621.

In some cases, the neural network architecture 600 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network architecture 600 is trained well enough so that the weights of the layers are accurately tuned.

To perform training, a loss function can be used to analyze an error in the output. Any suitable loss function definition can be used, such as a Cross-Entropy loss. Another example of a loss function includes the mean squared error (MSE), defined as E_total=Σ(½ (target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network architecture 600 can perform a backward pass by determining which inputs (weights) most contributed to the loss of the network, and can adjust the weights so that the loss decreases and is eventually minimized.

The neural network architecture 600 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network architecture 600 can include any other deep network other than a CNN, such as an autoencoder, Deep Belief Nets (DBNs), Recurrent Neural Networks (RNNs), among others.

As understood by those of skill in the art, machine-learning based techniques can vary depending on the desired implementation. For example, machine-learning schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 7 illustrates a flowchart of an example process 700 for training a machine learning model to determine simulation fidelity. Although the process 700 depicts a particular sequence of operations, the sequence may be altered without departing from the scope of the present disclosure. For example, some of the operations depicted may be performed in parallel or in a different sequence that does not materially affect the function of process 700. In other examples, different components of an example device or system that implements process 700 may perform functions at substantially the same time or in a specific sequence.

At step 702, the process 700 includes generating a first training dataset that is based on real-world data collected by an autonomous vehicle having a machine learning model. For example, simulator 308 can be used to generate real-world dataset 312 that is based on real-world data 302. In some aspects, real-world data 302 may correspond to data collected by AV 102, which includes machine learning models such as perception stack 112 and prediction stack 116, among others.

At step 704, the process 700 includes generating a second training dataset that is based on simulation data, wherein the simulation data corresponds to the real-world data. For instance, simulator 308 can be used to generate simulation dataset 310 that is based on synthetic data 306, and synthetic data 306 can correspond to real-world data 302. In some examples, the process 700 can include converting the real-world data into the simulation data. For instance, data converter 304 can convert real-world data 302 into synthetic data 306.

In some cases, generating the second training dataset can include performing one or more simulations using the simulation data, wherein a simulated position of the autonomous vehicle is configured to match an actual position of the autonomous vehicle for every simulation tick. For example, simulator 308 can be used to perform one or more simulations using synthetic data 306, and a simulated position of the autonomous vehicle (e.g., AV 102) can be configured to match an actual position (e.g., based on real-world data 302) for every simulation tick.

At step 706, the process 700 includes training a revised version of the machine learning model using the first training dataset and the second training dataset, wherein the revised version of the machine learning model includes a discriminator head that is configured to generate an input classifier that indicates whether input data to the machine learning model corresponds to real-world input data or simulated input data. For example, real-world dataset 312 and simulation dataset 310 can be used to train ML model 314. In some aspects, ML model 314 can include discriminator head 316 that is trained to generate an input classifier 320 that indicates whether input data to the machine learning model corresponds to real-world input data or simulated input data. In some aspects, the discriminator head (e.g., discriminator head 316) can determine the input classifier (e.g., input classifier 320) based on a feature vector generated by an intermediate layer of the machine learning model (e.g., ML model 314). In some configurations, the intermediate layer can correspond to a combined embedding layer.

In some aspects, the process 700 can include determining a fidelity score that is based on the input classifier. For example, fidelity score 322 can be determined based on input classifier 320. In some cases, the fidelity score can be based on an area under a receiver operating characteristic curve.

FIG. 8 illustrates a flowchart of an example process 800 for determining simulation fidelity. Although the process 800 depicts a particular sequence of operations, the sequence may be altered without departing from the scope of the present disclosure. For example, some of the operations depicted may be performed in parallel or in a different sequence that does not materially affect the function of process 800. In other examples, different components of an example device or system that implements process 800 may perform functions at substantially the same time or in a specific sequence.

At step 802, the process 800 includes receiving, by a machine learning model, a plurality of input datasets that are generated as part of a simulated scene within a simulation environment. For example, ML model 404 can receive simulation data 402. In some aspects, simulation data 402 may be part of a scene within a simulation environment such as simulator 232. In some aspects, the machine learning model can correspond to at least one of a perception stack of an autonomous vehicle (AV), a prediction stack of an AV, and a planning stack of an AV. In some cases, the plurality of input datasets can include synthetic sensor data and synthetic object tracks that are associated with the simulated scene. For example, simulated data 402 can include synthetic sensor data and/or synthetic object tracks.

At step 804, the process 800 includes generating, by the machine learning model, a plurality of outputs that are based on the plurality of input datasets. For example, ML model 404 can generate output 410 that is based on simulation data 402.

At step 806, the process 800 includes determining, by a discriminator head of the machine learning model, a plurality of input classifiers for each of the plurality of outputs, wherein each input classifier from the plurality of input classifiers indicates whether input data corresponding to a respective output from the plurality of outputs is associated with simulated input data or real-world input data. For instance, discriminator head 408 of ML model 404 can determine input classifier 412 that corresponds to output 410, and input classifier 412 can indicate whether simulation data 402 corresponding to output 410 is synthetic data or real-world data. In some cases, the discriminator head can determine the plurality of input classifiers based on a feature vector generated by an intermediate layer of the machine learning model. For example, discriminator head 408 can determine input classifier 412 based on a feature vector (e.g., embeddings) generated by an intermediate layer of ML model 404.

In some examples, the process 800 can include identifying at least one input feature within the plurality of input datasets that is used by the discriminator head to classify the input data as simulated input data, wherein the at least one input feature reduces a simulation fidelity associated with the simulated scene. For example, simulation analysis 416 can be used to identify an input feature within simulation data 402 that is used by discriminator head 408 to classify simulation data 402 as synthetic (e.g., simulated) input data. The input feature identified by simulation analysis 416 can adversely affect the fidelity of the simulation.

In some aspects, the process 800 can include determining a simulation fidelity score for the simulated scene, wherein the simulation fidelity score is based on the plurality of input classifiers determined by the discriminator head. For example, fidelity score 414 can be determined based on input classifier 412. In some configurations, the simulation fidelity score can be based on an area under a receiver operating characteristic curve.

FIG. 9 illustrates an example processor-based system with which some aspects of the subject technology can be implemented. For example, processor-based system 900 can be any computing device making up local computing device 110, client computing device 170, a passenger device executing the ridesharing application 172, or any component thereof in which the components of the system are in communication with each other using connection 905. Connection 905 can be a physical connection via a bus, or a direct connection into processor 910, such as in a chipset architecture. Connection 905 can also be a virtual connection, networked connection, or logical connection.

In some examples, computing system 900 is a distributed system in which the functions described in this disclosure can be distributed within a datacenter, multiple data centers, a peer network, etc. In some cases, one or more of the described system components represents many such components each performing some or all of the function for which the component is described. In some cases, the components can be physical or virtual devices.

Example system 900 includes at least one processing unit (CPU or processor) 910 and connection 905 that couples various system components including system memory 915, such as read-only memory (ROM) 920 and random-access memory (RAM) 925 to processor 910. Computing system 900 can include a cache of high-speed memory 912 connected directly with, in close proximity to, and/or integrated as part of processor 910.

Processor 910 can include any general-purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 can include an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms known to those of skill in the art. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L #), resistive random-access memory (RRAM/ReRAM), phase change memory (PCM), spin transfer torque RAM (STT-RAM), another memory chip or cartridge, and/or a combination thereof.

Storage device 930 can include software services, servers, services, etc., that when the code that defines such software is executed by the processor 910, causes the system to perform a function. In some examples, a hardware service that performs a particular function can include the software component stored in a computer-readable medium in connection with the necessary hardware components, such as processor 910, connection 905, output device 935, etc., to carry out the function.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A method comprising: receiving, by a machine learning model, a plurality of input datasets that are generated as part of a simulated scene within a simulation environment; generating, by the machine learning model, a plurality of outputs that are based on the plurality of input datasets; and determine, by a discriminator head of the machine learning model, a plurality of input classifiers for each of the plurality of outputs, wherein each input classifier from the plurality of input classifiers indicates whether input data corresponding to a respective output from the plurality of outputs is associated with simulated input data or real-world input data.

Aspect 2. The method of Aspect 1, further comprising: identifying at least one input feature within the plurality of input datasets that is used by the discriminator head to classify the input data as simulated input data, wherein the at least one input feature reduces a simulation fidelity associated with the simulated scene.

Aspect 3. The method of any of Aspects 1 to 2, further comprising: determining a simulation fidelity score for the simulated scene, wherein the simulation fidelity score is based on the plurality of input classifiers determined by the discriminator head.

Aspect 4. The method of Aspect 3, wherein the simulation fidelity score indicates whether the simulated scene is distinguishable from a corresponding real-world environment.

Aspect 5. The method of any of Aspects 3 to 4, wherein the simulation fidelity score is based on an area under a receiver operating characteristic curve.

Aspect 6. The method of any of Aspects 3 to 5, wherein the simulation fidelity score has a value from zero to one.

Aspect 7. The method of any of Aspect 1 to 6, wherein the discriminator head determines the plurality of input classifiers based on a feature vector generated by an intermediate layer of the machine learning model.

Aspect 8. The method of Aspect 7, wherein the feature vector includes compressed object features from the input dataset.

Aspect 9. The method of any of Aspects 1 to 8, wherein the machine learning model corresponds to at least one of a perception stack of an autonomous vehicle (AV), a prediction stack of an AV, and a planning stack of an AV.

Aspect 10. The method of any of Aspects 1 to 9, wherein the plurality of input datasets includes synthetic sensor data and synthetic object tracks that are associated with the simulated scene.

Aspect 11. An apparatus comprising: at least one memory; and at least one processor coupled to the at least one memory, wherein the at least one processor is configured to perform operations in accordance with any one of Aspects 1 to 10.

Aspect 12. An apparatus comprising means for performing operations in accordance with any one of Aspects 1 to 10.

Aspect 13. A non-transitory computer-readable medium comprising instructions that, when executed by an apparatus, cause the apparatus to perform operations in accordance with any one of Aspects 1 to 10.

Aspect 14. A method comprising: generating a first training dataset that is based on real-world data collected by an autonomous vehicle having a machine learning model; generating a second training dataset that is based on simulation data, wherein the simulation data corresponds to the real-world data; and training a revised version of the machine learning model using the first training dataset and the second training dataset, wherein the revised version of the machine learning model includes a discriminator head that is configured to generate an input classifier that indicates whether input data to the machine learning model corresponds to real-world input data or simulated input data.

Aspect 15. The method of Aspect 14, further comprising: converting the real-world data into the simulation data.

Aspect 16. The method of any of Aspects 14 to 15, wherein the discriminator head determines the input classifier based on a feature vector generated by an intermediate layer of the machine learning model.

Aspect 17. The method of Aspect 16, wherein the intermediate layer corresponds to a combined embedding layer.

Aspect 18. The method of any of Aspects 14 to 17, wherein generating the second training dataset that is based on simulation data further comprises: performing one or more simulations using the simulation data, wherein a simulated position of the autonomous vehicle is configured to match an actual position of the autonomous vehicle for every simulation tick.

Aspect 19. The method of any of Aspects 14 to 18, further comprising: determining a fidelity score that is based on the input classifier.

Aspect 20. The method of any of Aspects 14 to 19, wherein the fidelity score is based on an area under a receiver operating characteristic curve.

Aspect 21. An apparatus comprising: at least one memory; and at least one processor coupled to the at least one memory, wherein the at least one processor is configured to perform operations in accordance with any one of Aspects 14 to 20.

Aspect 22. An apparatus comprising means for performing operations in accordance with any one of Aspects 14 to 20.

Aspect 23. A non-transitory computer-readable medium comprising instructions that, when executed by an apparatus, cause the apparatus to perform operations in accordance with any one of Aspects 14 to 20.

What is claimed is:

1. A system comprising:
a memory; and
one or more processors coupled to the memory, the one or more processors being configured to:
receive, by a machine learning model, a plurality of input datasets that are generated as part of a simulated scene within a simulation environment;
generate, by the machine learning model, a plurality of outputs that are based on the plurality of input datasets; and
determine, by a discriminator head of the machine learning model, a plurality of input classifiers for each of the plurality of outputs, wherein each input classifier from the plurality of input classifiers indicates whether input data corresponding to a respective output from the plurality of outputs is associated with simulated input data or real-world input data.

2. The system of claim 1, wherein the one or more processors are further configured to:
identify at least one input feature within the plurality of input datasets that is used by the discriminator head to classify the input data as simulated input data, wherein the at least one input feature reduces a simulation fidelity associated with the simulated scene.

3. The system of claim 1, wherein the one or more processors are further configured to:
determine a simulation fidelity score for the simulated scene, wherein the simulation fidelity score is based on the plurality of input classifiers determined by the discriminator head.

4. The system of claim 3, wherein the simulation fidelity score is based on an area under a receiver operating characteristic curve.

5. The system of claim 1, wherein the discriminator head determines the plurality of input classifiers based on a feature vector generated by an intermediate layer of the machine learning model.

6. The system of claim 1, wherein the machine learning model corresponds to at least one of a perception stack of an autonomous vehicle (AV), a prediction stack of an AV, and a planning stack of an AV.

7. The system of claim 1, wherein the plurality of input datasets includes synthetic sensor data and synthetic object tracks that are associated with the simulated scene.

8. A computer-implemented method comprising:
receiving, by a machine learning model, a plurality of input datasets that are generated as part of a simulated scene within a simulation environment;
generating, by the machine learning model, a plurality of outputs that are based on the plurality of input datasets; and
determining, by a discriminator head of the machine learning model, a plurality of input classifiers for each of the plurality of outputs, wherein each input classifier from the plurality of input classifiers indicates whether input data corresponding to a respective output from the plurality of outputs is associated with simulated input data or real-world input data.

9. The computer-implemented method of claim 8, further comprising:
identifying at least one input feature within the plurality of input datasets that is used by the discriminator head to classify the input data as simulated input data, wherein the at least one input feature reduces a simulation fidelity associated with the simulated scene.

10. The computer-implemented method of claim 8, further comprising:
determining a simulation fidelity score for the simulated scene, wherein the simulation fidelity score is based on the plurality of input classifiers determined by the discriminator head, and wherein the simulation fidelity score indicates whether the simulated scene is distinguishable from a corresponding real-world environment.

11. The computer-implemented method of claim 10, wherein the simulation fidelity score is based on an area under a receiver operating characteristic curve, and wherein the simulation fidelity score has a value from zero to one.

12. The computer-implemented method of claim 8, wherein the discriminator head determines the plurality of input classifiers based on a feature vector generated by an intermediate layer of the machine learning model, wherein the feature vector includes compressed object features from the input dataset.

13. The computer-implemented method of claim 8, wherein the machine learning model corresponds to at least one of a perception stack of an autonomous vehicle (AV), a prediction stack of an AV, and a planning stack of an AV.

14. A system comprising:
a memory; and
one or more processors coupled to the memory, the one or more processors being configured to:
generate a first training dataset that is based on real-world data collected by an autonomous vehicle having a machine learning model;
generate a second training dataset that is based on simulation data, wherein the simulation data corresponds to the real-world data; and
train a revised version of the machine learning model using the first training dataset and the second training dataset, wherein the revised version of the machine learning model includes a discriminator head that is configured to generate an input classifier that indicates whether input data to the machine learning model corresponds to real-world input data or simulated input data.

15. The system of claim 14, wherein the one or more processors are further configured to:
convert the real-world data into the simulation data.

16. The system of claim 14, wherein the discriminator head determines the input classifier based on a feature vector generated by an intermediate layer of the machine learning model.

17. The system of claim 16, wherein the intermediate layer corresponds to a combined embedding layer.

18. The system of claim 14, wherein to generate the second training dataset that is based on simulation data the one or more processors are further configured to:
perform one or more simulations using the simulation data, wherein a simulated position of the autonomous vehicle is configured to match an actual position of the autonomous vehicle for every simulation tick.

19. The system of claim 14, wherein the one or more processors are further configured to:
determine a fidelity score that is based on the input classifier.

20. The system of claim 19, wherein the fidelity score is based on an area under a receiver operating characteristic curve.
